(19) United States
(12) Patent Application Publication
(10) Pub. No.: US 2026/0029581 A1
(43) Pub. Date: Jan. 29, 2026

(54) LOW LOSS CONNECTION BETWEEN HOLLOW-CORE OPTICAL FIBERS USING TUBE FIBER AS AN OPTICAL COUPLER

(71) Applicant: CORNING RESEARCH & DEVELOPMENT CORPORATION, Corning, NY (US)

(72) Inventors: Xin Chen, Painted Post, NY (US); Jason Edward Hurley, Corning, NY (US); Ming-Jun Li, Horseheads, NY (US); Jie Liu, Painted Post, NY (US)

(21) Appl. No.: 19/247,443

(22) Filed: Jun. 24, 2025

Related U.S. Application Data
(60) Provisional application No. 63/674,351, filed on Jul. 23, 2024.

(51) Int. Cl. G02B 6/26; G02B 6/255

(52) U.S. Cl. CPC G02B 6/262; G02B 6/2551

(57) ABSTRACT

A system and method for coupling hollow-core optical fibers. The system operatively couples one hollow-core optical fiber to another hollow-core optical fiber using a length of tube fiber. The end face of each hollow-core optical fiber is operatively coupled to a respective end face of the tube fiber, e.g., by fusion splicing or another suitable means of connecting optical fibers. In operation, light propagating through one of the hollow-core optical fibers is transmitted into an end face of the tube fiber, propagates through the tube fiber, and is emitted from the other end face of the tube fiber and into the other hollow-core optical fiber.

### PRIORITY APPLICATION

This application claims the benefit of priority of U.S. Provisional Application No. 63/674,351, filed on Jul. 23, 2024, the content of which is relied upon and incorporated herein by reference in its entirety.

### TECHNICAL FIELD

This disclosure relates generally to optical connectivity, and more particularly to methods of optically coupling hollow-core optical fibers to each other.

### BACKGROUND

Optical fibers are useful in a wide variety of applications, including the telecommunications industry for voice, video, and data transmissions. Benefits of optical fibers include wide bandwidth and low noise operation. Traditional optical fibers include a solid core and a solid cladding that surrounds the core. The core and cladding are typically made of fused silica doped so that the core has a higher index of refraction than the cladding. The core and cladding of the optical fiber are thereby configured to define an optical waveguide that generally confines optical beams propagating through the optical fiber to a region of the optical fiber within and immediately adjacent to the core.

Hollow-core optical fiber is a relatively new type of optical fiber that guides light through a hollow air-filled core rather than through a solid silica core. The latest hollow-core optical fiber designs include an anti-resonant structure that can confine light over a broader range of wavelengths as compared to earlier photonic bandgap hollow-core optical fibers. These anti-resonant structures enable lower-loss transmission over a wider usable wavelength window than previously available from hollow-core optical fibers. A double nested anti-resonant nodeless optical fiber (DNANF) has been reported as having an attenuation level of 0.174 dB/km at 1550 nm, which is comparable to the performance of germanium doped all-glass fibers. In a more recent paper from OFC 2024, a hollow-core DNANF optical fiber was reported as having a loss of less than 0.11 dB/km. Thus, the performance of hollow-core optical fibers has become competitive with traditional solid-core optical fibers for long-haul transmission.

Hollow-core optical fiber has an effective index of refraction similar to that of air. As a result, light propagates through hollow-core optical fiber at essentially the same speed as light in vacuum (300,000 km/sec), which is about 50% faster than the speed at which light typically propagates through solid-core optical fiber (200,000 km/s). Thus, hollow-core optical fiber offers significantly reduced latency compared to solid-core optical fiber. Due to the improvements in signal loss and useable wavelengths resulting from recent research and development, hollow-core optical fiber is becoming increasingly attractive for use in commercial applications.

One way of connecting hollow-core optical fibers is by direct splicing. However, direct splicing is generally difficult and expensive to implement with hollow-core optical fibers. In particular, the anti-resonant structures of the hollow-core optical fibers being spliced must be individually aligned in order to have low losses across the splice. This additional requirement for rotational alignment about the center axes of the hollow-core optical fibers being spliced significantly increases the difficulty of obtaining a good splice.

Thus, there is a need in the fiber optic industry for improved systems and methods of optically coupling hollow-core optical fibers. More particularly, there is a need for systems and methods of operatively coupling hollow-core optical fibers that result in a low-loss connection and avoid the need for rotational alignment.

### SUMMARY

In one aspect of the disclosure, an improved system for coupling optical fibers is disclosed. The system includes a first hollow-core optical fiber including a first hollow-core optical fiber end face, a tube fiber including a first tube fiber end face and a second tube fiber end face, and a second hollow-core optical fiber including a second hollow-core optical fiber end face that is operatively coupled to the first hollow-core optical fiber end face by the tube fiber.

In one embodiment of the disclosed system, the first hollow-core optical fiber end face may be connected to the first tube fiber end face, and the second hollow-core optical fiber end face may be connected to the second tube fiber end face.

In another embodiment of the disclosed system, the first hollow-core optical fiber end face may be connected to the first tube fiber end face by a first fusion splice, and the second hollow-core optical fiber end face may be connected to the second tube fiber end face by a second fusion splice.

In another embodiment of the disclosed system, the tube fiber may have a length of between 180 μm and 220 μm.

In another embodiment of the disclosed system, each hollow-core optical fiber may include a mode field diameter and a cladding having an inner cladding diameter larger than the mode field diameter, and the tube fiber may include a lumen having a lumen diameter greater than or equal to the mode field diameter and less than or equal to the inner cladding diameter.

In another embodiment of the disclosed system, each hollow-core optical fiber may include a hollow-core having a hollow-core diameter less than the inner cladding diameter and greater than the mode field diameter, and the lumen diameter may be greater than or equal to the mode field diameter and less than or equal to the hollow-core diameter.

In another embodiment of the disclosed system, the lumen diameter may be the same as the hollow-core diameter.

In another embodiment of the disclosed system, the tube fiber may include an inner layer having a first index of refraction and a surface that defines the lumen diameter, and an outer layer in contact with the inner layer and having a second index of refraction different from the first index of refraction.

In another embodiment of the disclosed system, the first index of refraction may be greater than the second index of refraction.

In another embodiment of the disclosed system, the inner layer may be configured to be an anti-resonant layer.

In another aspect of the disclosure, an improved method of coupling optical fibers is disclosed. The method includes operatively coupling the first hollow-core optical fiber end face of the first hollow-core optical fiber to the first tube fiber end face of the tube fiber, and operatively coupling the second hollow-core optical fiber end face of the second hollow-core optical fiber to the second tube fiber end face of the tube fiber.

In one embodiment of the disclosed method, operatively coupling the first hollow-core optical fiber end face to the first tube fiber end face may include connecting the first hollow-core optical fiber end face to the first tube fiber end face, and operatively coupling the second hollow-core optical fiber end face to the second tube fiber end face may include connecting the second hollow-core optical fiber end face to the second tube fiber end face.

In another embodiment of the disclosed method, connecting the first hollow-core optical fiber end face to the first tube fiber end face may include fusion splicing the first hollow-core optical fiber end face to the first tube fiber end face, and connecting the second hollow-core optical fiber end face to the second tube fiber end face may include fusion splicing the second hollow-core optical fiber end face to the second tube fiber end face.

In another embodiment of the disclosed method, the tube fiber may have a length of between 180 μm and 220 μm.

In another embodiment of the disclosed method, each hollow-core optical fiber may include the mode field diameter and the cladding having the inner cladding diameter larger than the mode field diameter, and the tube fiber may include the lumen having the lumen diameter greater than or equal to the mode field diameter and less than or equal to the inner cladding diameter.

In another embodiment of the disclosed method, each hollow-core optical fiber may include the hollow-core having the hollow-core diameter less than the inner cladding diameter and greater than the mode field diameter, and the lumen diameter may be greater than or equal to the mode field diameter and less than or equal to the hollow-core diameter.

In another embodiment of the disclosed method, the lumen diameter may be the same as the hollow-core diameter.

In another embodiment of the disclosed method, the tube fiber may include the lumen having the lumen diameter, the inner layer having the first index of refraction and the surface that defines the lumen diameter, and the outer layer in contact with the inner layer and having the second index of refraction different from the first index of refraction.

In another embodiment of the disclosed method, the first index of refraction may be greater than the second index of refraction.

In another embodiment of the disclosed method, the inner layer may be configured to be the anti-resonant layer.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a diagrammatic cross-sectional view of an exemplary hollow-core optical fiber.

FIG. 2 is graphical view of the hollow-core optical fiber of FIG. 1 showing the refractive indexes of different regions of the hollow-core optical fiber.

FIG. 3 is a graphical view of a beam of light propagating through a length of the hollow-core optical fiber of FIG. 1 and being emitted into air from the hollow-core optical fiber.

FIG. 4 is a diagrammatic cross-sectional view of an exemplary tube fiber.

FIG. 5 is a diagrammatic cross-sectional view of another exemplary tube fiber including an inner layer and an outer layer.

FIG. 6 is a graphical view of a beam of light propagating through a length of the hollow-core optical fiber of FIG. 1 followed by a length of the tube fiber of FIG. 5.

FIG. 7 is a diagrammatic view of a fiber optic coupling system that couples two hollow-core optical fibers of FIG. 1 using a length of the tube fiber of either FIG. 4 or FIG. 5.

FIG. 8 is a graphical view of a beam of light propagating sequentially through a length of the hollow-core optical fiber of FIG. 1, a length of the tube fiber of FIG. 4 or FIG. 5, and another length of the hollow-core optical fiber of FIG. 1.

FIGS. 9 and 10 are graphical views of the intensity distribution of the beam of light of FIG. 8 at different positions along the sequence of fibers.

FIG. 11 is a perspective view of another fiber optic coupling system that couples two of the hollow-core optical fibers of FIG. 1 using a length of the tube fiber of FIG. 5.

FIG. 12 is a diagrammatic view of a three-dimensional refractive index profile of the tube fiber of FIG. 5 which was used to model of the fiber optic coupling system of FIG. 11.

FIGS. 13-16 are graphical views of the intensity distribution of a cross-section of a beam of light propagating through the fiber optic coupling system of FIG. 11 at different positions in the fiber optic coupling system.

FIGS. 17 and 18 are graphical views the E-field profile of a Gaussian beam of light and a beam of light at a transition between the tube fiber and a hollow-core optical fiber of the fiber optic coupling system of FIG. 11.

FIG. 19 is a perspective view of another fiber optic coupling system that couples two of the hollow-core optical fibers of FIG. 1 using a length of the tube fiber of FIG. 5 with a different inner diameter than the tube fiber of FIG. 11.

FIG. 20 is a diagrammatic view of a three-dimensional refractive index profile of the tube fiber of FIG. 5 which was used to model of the fiber optic coupling system of FIG. 19.

FIGS. 21-24 are graphical views of the intensity distribution of a cross-section of a beam of light propagating through the fiber optic coupling system of FIG. 19 at different positions in the fiber optic coupling system.

FIGS. 25 and 26 are graphical views the E-field profile of a Gaussian beam of light and a beam of light at a transition between the tube fiber and a hollow-core optical fiber of the fiber optic coupling system of FIG. 19.

FIG. 27 is a photographic view of an exemplary fiber optic coupling system similar to those depicted in FIGS. 7, 11, and 19.

It should be understood that the appended drawings are not necessarily to scale, and may present a somewhat simplified representation of various features illustrative of the basic principles of the disclosure. For example, certain features illustrated by the drawings may be enlarged or distorted relative to others to facilitate visualization and a clear understanding.

### DETAILED DESCRIPTION

Various embodiments will be further clarified by examples in the description below. In general, the description relates to systems and methods that enable connectivity between one hollow-core optical fiber and another hollow-core optical fiber. These systems and methods use a tube fiber having an outer diameter similar to the outer diameters of the hollow-core optical fibers which are being operatively coupled by the tube fiber.

The tube fiber may be configured to have the same outer diameter as the cladding of the hollow-core optical fiber, e.g., by using a drawing process to set the outer diameter of the tube fiber. The resulting tube fiber may be used to fabricate optical couplers that provide a low-loss connection between hollow-core optical fibers. The tube fiber may comprise a hollow tube that lacks structural tubes (e.g., a hollow tube having a smooth inner surface) to avoid the need to rotationally align the structural tubes as is normally required when splicing hollow-core optical fibers directly to each other. The ability to provide low-loss optical connections without the need for rotational alignment simplifies the splicing process and may improve the percentage of splices that have an acceptable insertion loss.

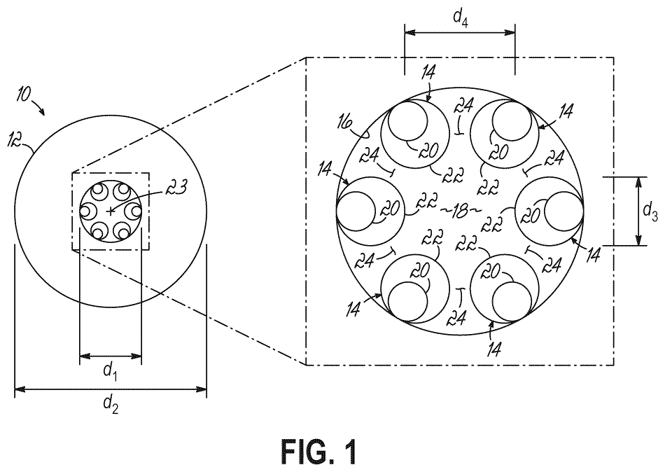

FIG. 1 depicts an axial cross-sectional view of an exemplary embodiment of a hollow-core optical fiber 10. The hollow-core optical fiber 10 includes a cladding 12 and a plurality of structural tubes 14. The cladding 12 includes an inner surface 16 on which the structural tubes 14 are arranged circumferentially to define a hollow-core 18. The depicted embodiment includes six structural tubes 14 each having a nested structure comprising an inner tube 20 and an outer tube 22. However, it should be understood that the fiber optic coupling systems and methods disclosed herein may be used with hollow-core optical fibers 10 having other numbers of structural tubes 14, as well as structural tubes 14 that comprise a single tube (i.e., unnested structural tubes 14) or include more than two nested tubes.

The cladding 12 and structural tubes 14 may be formed, for example, of doped or undoped silica glass. The cladding 12 may have an inner diameter d₁ and an outer diameter d₂, and the structural tubes 14 may have an outer diameter d₃. The dimensions of the cladding 12 and structural tubes 14 may be selected so that the hollow-core 18 has a diameter d₄. The diameter d₄ of the hollow-core 18 may be defined, for example, as twice the minimum distance between the surface of each structural tube 14 and an optical axis 23 of the hollow-core optical fiber 10. The dimensions of the cladding 12 and structural tubes 14 may be selected so that adjacent structural tubes 14 are separated by a gap 24. The gap 24 may prevent adjacent structural tubes 14 from contacting each other. The presence of the gap 24 may thereby prevent the formation of a waveguide along a line of contact between the structural tubes 14 due to a doubling of the wall thickness of the structural tubes 14 where the structural tubes 14 come into contact.

The dimensions and other characteristics of the cladding 12 and structural tubes 14 (e.g., the refractive index or indices) may be selected to define a waveguide that generally confines optical beams propagating through the hollow-core optical fiber 10 to the hollow-core 18 itself. The thicknesses of the walls of the structural tubes 14 may be selected to provide an anti-resonant effect that reduces leakage of optical beams from the hollow-core 18 into the structural tubes 14. This anti-resonant effect may be optimized by providing the structural tubes 14 with a wall thickness that is an odd multiple of a quarter wavelength of the optical beam. In an exemplary embodiment of the depicted hollow-core optical fiber 10, d₁ may be about 100 μm, d₂ may be about 250 μm, d₃ may be about 30 μm, and d₄ may be about 40 μm. However, it should be understood that the fiber optic coupling systems and methods disclosed herein are not limited to hollow-core optical fibers 10 having a particular set of structural dimensions.

Hollow-core optical fibers 10 may have different structures, which include unnested anti-resonant hollow-core optical fiber 10, single nested anti-resonant hollow-core optical fiber 10 (depicted by FIG. 1), and multiple nested (e.g., double nested) anti-resonant hollow-core optical fiber 10. One type of hollow-core optical fiber 10 manufactured for internal use by Corning Inc, an optical technology company headquartered in Corning, New York, United States, has a nominal mode field diameter of 32 μm. This mode field diameter is larger than those reported for hollow-core optical fibers 10 in the literature, which typically have a mode field diameter in the range of 10-22 μm for double nested anti-resonant nodeless optical fiber, and 22-28 μm for single nested anti-resonant nodeless fiber.

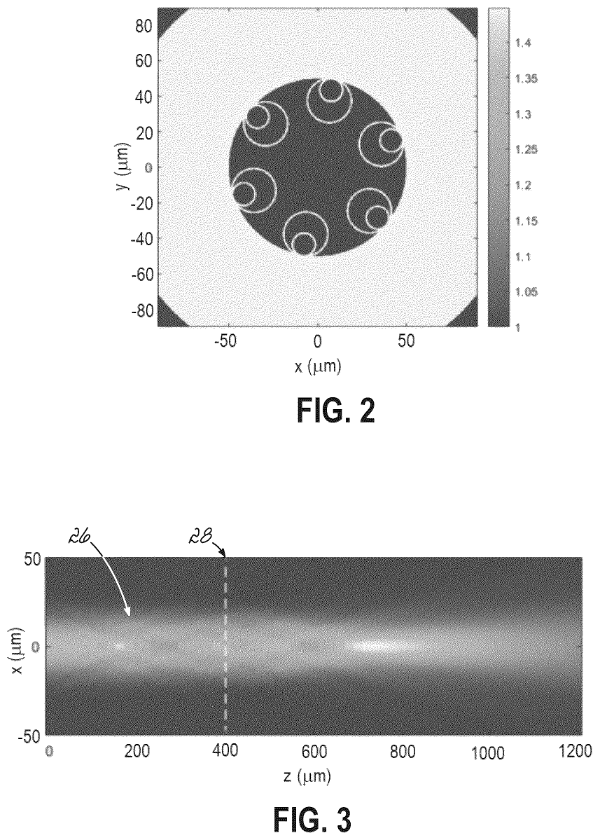

Coupling loss modeling was conducted using BPM-Matlab, which is an open-source optical propagation simulation tool in MATLAB. MATLAB is proprietary multi-paradigm programming language and numeric computing environment developed by MathWorks, a corporation located in Natick, Massachusetts, United States. FIG. 2 is a cross-sectional view of the hollow-core optical fiber 10 of FIG. 1 showing the real part of the refractive index. As can be seen from the shading, hollow-areas have a refractive index of about 1.00 and areas occupied by the silica structure of the hollow-core optical fiber 10 have a refractive index of about 1.44.

FIG. 3 depicts a graph illustrating the propagation of a beam of light 26 through a 400 μm length of hollow-core optical fiber 10 followed by 800 μm of air. The transition 28 from the hollow-core optical fiber 10 to air occurs at z=400 μm, and is indicated by a dashed line. The shading of the graph indicates the distribution of light as a function of position along the x and z-axes as the beam of light 26 propagates along the z-axis. The beam of light 26 is launched into the hollow-core optical fiber 10 at z=0 as a Gaussian beam with a mode field diameter of 39 μm. The beam of light 26 shows some z-position dependence as it propagates through the hollow-core optical fiber 10. This z-position dependence may be due to the existence of both a fundamental mode and one or more higher order modes in the hollow-core optical fiber 10. As a result, the beam of light 26 forms a beam waist at about z=160 μm before re-expanding.

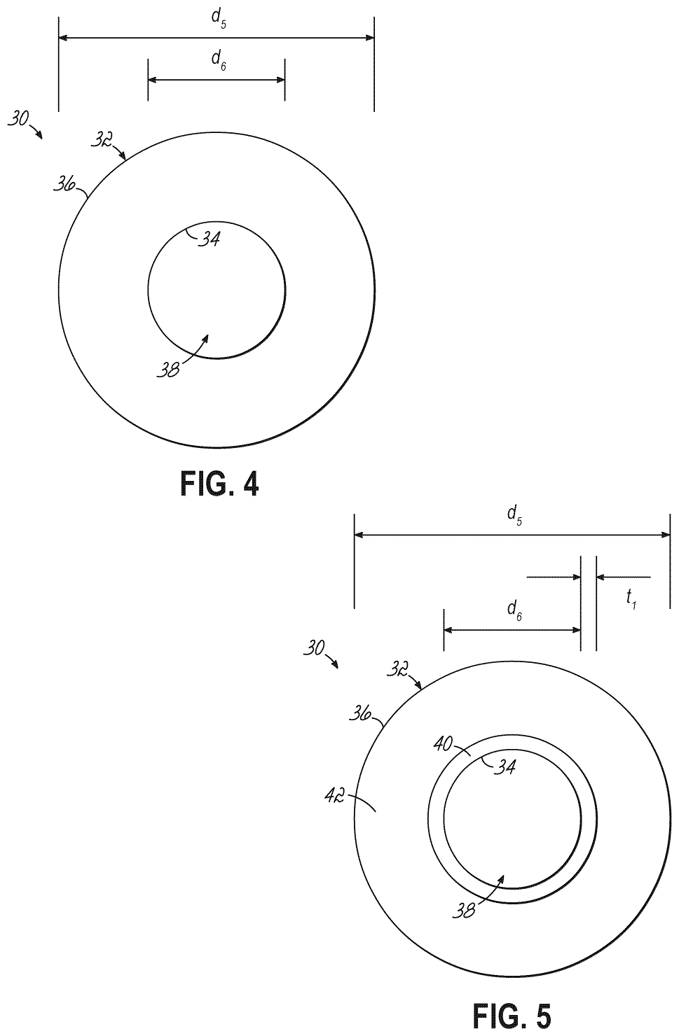

FIG. 4 depicts an exemplary embodiment of a tube fiber 30 including a cylindrical wall 32 that defines an inner surface 34 and an outer surface 36 of tube fiber 30, with the inner surface 34 defining a lumen 38 of tube fiber 30. The cylindrical wall 32 may be made of pure silica, doped silica, or any other suitable material. The tube fiber 30 may have an outer diameter d₅ and an inner diameter do, with the inner diameter d₆ defining the dimensions of the lumen 38. FIG. 5 depicts an embodiment of the tube fiber 30 which the cylindrical wall 32 includes a plurality of layers, e.g., an inner layer 40 and an outer layer 42, with the inner layer 40 defining the inner surface 34 of tube fiber 30, and the outer layer 42 defining the outer surface 36 of tube fiber 30. The inner layer 40 may have a thickness t₁ and a higher index of refraction than the outer layer 42. The inner layer 40 may be doped with Ge, Ti, Al, P, or other suitable dopants (e.g., GeO₂) to increase the inner layer's refractive index. In an alternative embodiment, the outer layer 42 may be doped with F, B₂O₃, or other suitable dopants to lower its refractive index. The relative refractive index change may range from 0.3% to 5%, and the thickness t₁ may range from 0.5 to 5 μm.

The inner layer 40 may be configured as an anti-resonant layer that further confines the light traveling inside the tube fiber 30 as compared to embodiments lacking the inner layer 40. To this end, the thickness of inner layer 40 that provides an anti-resonant effect can be calculated approximately using the following equation,

$${t}_{1} = \frac{λ}{4 {n}_{1}} ( 2 N - 1 ) {( 1 - \frac{{n}_{c}^{2}}{{n}_{1}^{2}} + \frac{{λ}^{2}}{4 {n}_{1}^{2} {d}_{6}^{2}} )}^{0.5} , N = 1 , 2 , 3 \qquad Eqn . 1$$

where n₁ is the refractive index of the inner layer 40, n_{c} is the refractive index of the core (e.g., =1.000 for tube fiber 30), d₆ is the inner diameter of the tube fiber 30, and λ is the wavelength of light propagating through the tube fiber 30. Table I below shows the calculated anti-resonant thicknesses for inner layers 40 having three different refractive indices and two wavelengths of light for a core diameter of 34 μm. As can be seen, the optimal thickness changes slightly for different refractive index and different wavelength. For second and third order resonances, the anti-resonant thicknesses may be multiplied by three times and five times, respectively.

TABLE 1
ANTI-RESONANT INNER LAYER THICKNESS

| Refractive | Delta | Thickness (μm) | Thickness (μm) |
|---|---|---|---|
| Index | (%) | (1310 nm) | (1550 nm) |
| 1.525 | 5.17 | 0.284 | 0.336 |
| 1.475 | 2.08 | 0.302 | 0.357 |
| 1.459 | 1.02 | 0.308 | 0.365 |

Referring again to FIG. 1, and with continued reference to FIGS. 4 and 5, in each of the depicted embodiments, the tube fiber 30 may have about the same outer diameter d₅ as the hollow-core optical fibers 10 being operatively coupled by the tube fiber 30, e.g., d₆≈d₅. The diameter d₆ of the lumen 38 of tube fiber 30 may range from about 110 μm to about 25 μm, more preferably from about the inner diameter d₁ of the cladding to the nominal mode field diameter of the hollow-core optical fibers 10 (e.g., 100 μm to 32 μm), and even more preferably, about the diameter d₄ of the hollow-core 18 of optical fibers 10 (e.g., 40 μm) or the mode field diameter of the hollow-core optical fiber 10 (e.g., 32 μm).

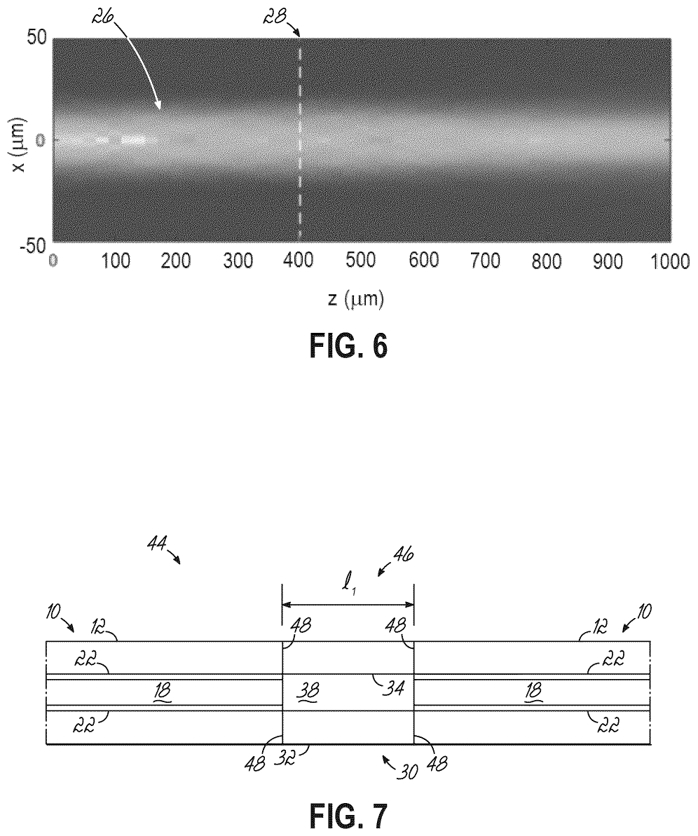

FIG. 6 depicts a graph illustrating propagation of a beam of light 26 through a 400 μm length of hollow-core optical fiber 10 followed by 600 μm length of tube fiber 30. The transition 28 from the hollow-core optical fiber 10 to the tube fiber 30 occurs at z=400 μm, as indicated by the dashed line. As can be seen, the beam of light 26 does not expand appreciably from z=400 μm to 600 μm. Thus, the tube fiber 30 may perform well as an optical coupler between hollow-core optical fibers 10 for lengths of up to at least 200 μm. The graph of FIG. 6 was generated by a model in which the beam of light 26 was launched into the hollow-core optical fiber 10 as a Gaussian beam with a mode field diameter of 34 μm, and the tube fiber 30 had the configuration depicted by FIG. 5 with an inner layer 40 having a refractive index delta relative to a pure silica outer layer 42 of Δ=0.3%. The refractive index delta A can be determined by the following equation,

$$Δ = \frac{{n}_{1}^{2} - {n}_{2}^{2}}{2 \times {n}_{1}^{2}} \qquad Eqn . 2$$

where n₁ is the refractive index of the inner layer 40 and n₂ is the refractive index of the outer layer 42.

FIG. 7 depicts an exemplary embodiment of a fiber optic coupling system 44 that includes an optical coupler 46 operatively coupling a pair of hollow-core optical fibers 10. The optical coupler 46 may include a length of tube fiber 30 in the configuration depicted by FIG. 5 with an outer diameter about the same as that of the hollow-core optical fibers 10, e.g., d₂=d₅. The tube fiber 30 may have a length l₁ of between 100 μm and 400 μm, preferably less than 200 μm. The end face 48 of each hollow-core optical fiber 10 (“hollow-core optical fiber end face”) may be connected to a respective end face 48 of the tube fiber 30 (“tube fiber end face”) using any suitable method. By way of example, connected end faces 48 may be fusion spliced, bonded using an optical adhesive, or otherwise held in place against each other by any suitable means. In some cases, a thin layer refractive index matching agent (e.g., a silicon-based liquid or gel), optical adhesive, or other suitable optical material may be introduced between the connected end faces 48 to improve the optical performance of the connection. FIG. 27 depicts an image of an exemplary embodiment of the fiber optic coupling system 44 of FIG. 7 in which the optical coupler 46 comprises a tube fiber 30, and the connected end faces 48 have been connected by a fusion splicing.

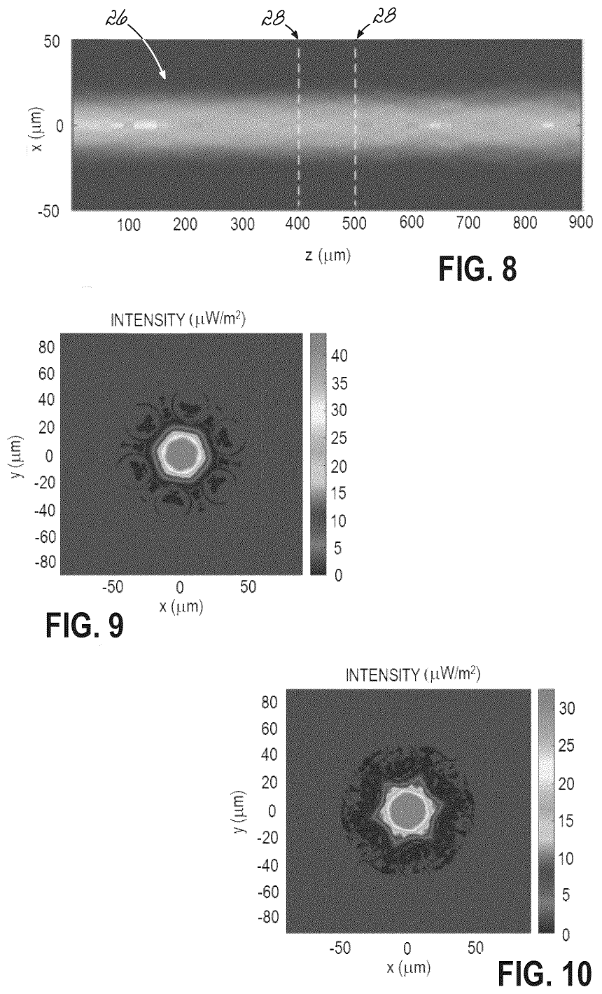

FIG. 8 depicts a graph illustrating a beam of light 26 propagating sequentially from left to right through a 400 μm length of hollow-core optical fiber 10, a 100 length of tube fiber 30, and another 400 μm length of hollow-core optical fiber 10. The transition 28 from hollow-core optical fiber 10 to tube fiber 30 is positioned at z=400 μm, and the transition 28 from tube fiber 30 to hollow-core optical fiber 10 is positioned at z=500 μm. FIGS. 9 and 10 depict graphs of the intensity of the beam of light 26 of FIG. 8 in μW/m² at z=400 μm and z=800 μm, respectively.

As can be seen from the graphs of FIGS. 9 and 10, the beam widths are similar at z=400 μm and z=800 μm, and the energy is largely confined to a central region of the lumen 38 of tube fiber 30. However, some transit effects can also be seen in the outer portion of the intensity images. These transit effects may be due to the presence of high-order modes at z=0 where the beam of light 26 is launched into the hollow-core optical fiber 10. To simulate a worst-case splicing condition, the hollow-core optical fibers 10 were given different rotational orientations in the model depicted by FIGS. 8-10. That is, the hollow-core optical fibers 10 were rotated about their respective optical axes 23 relative to each other so that the structural tubes 14 were not rotationally aligned, but rather rotationally offset to provide a worst-case rotational alignment.

To evaluate the effectiveness of the disclosed fiber optic coupling systems, two systems with differently configured optical couplers 46 were modelled, and simulated performance characteristics generated based on each model. The optical coupler 46 of the fiber optic coupling system 44 was configured with the same length (e.g., l₁=200 μm) but a different inner diameter (e.g., d₆=110 μm and d₆=40 μm) in each model. All simulations were conducted at a wavelength λ=1550 nm and with a maximum angular mismatch between the rotational orientations of the originating hollow-core optical fiber 10 and the destination hollow-core optical fiber 10. For hollow-core optical fibers 10 having six equally spaced structural tubes 14 such as depicted by FIG. 1, the maximum angular mismatch occurs when the hollow-core optical fibers 10 are oriented relative to each other such that the structural tubes 14 are misaligned by 30 degrees. Thus, the relative orientations of the hollow-core optical fibers were selected so that each structural tube 14 of one hollow-core optical fiber 10 was essentially aligned with the gap 24 of the other hollow-core optical fiber 10. This level of rotational misalignment presents a worst-case scenario for determining performance of the fiber optic coupling system 44.

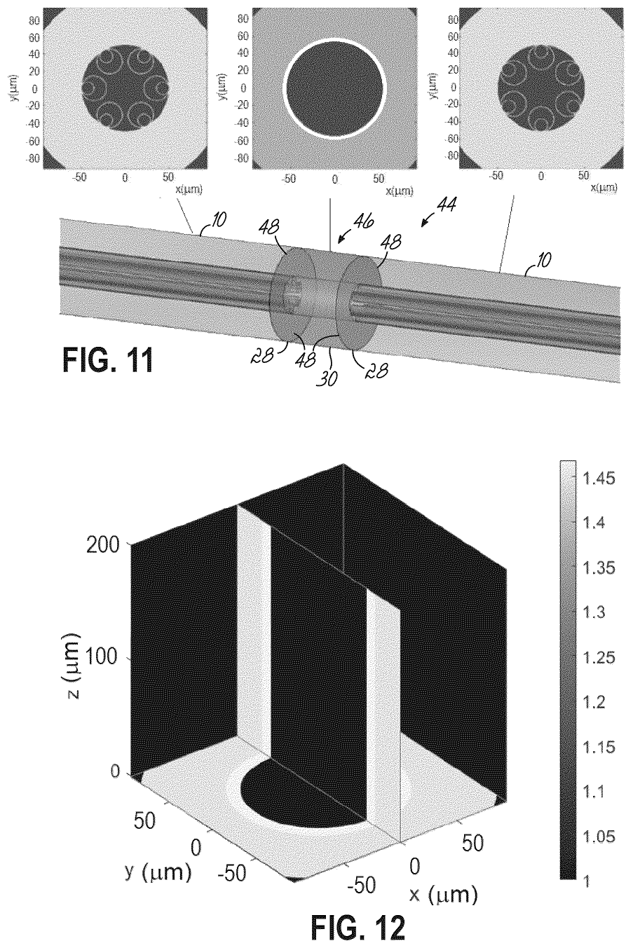

FIG. 11 depicts an exemplary embodiment of the fiber optic coupling system 44 in accordance with one of the above-described models. The depicted fiber optic coupling system 44 includes two hollow-core optical fibers 10 operatively coupled to each other by an optical coupler 46 comprising a length of tube fiber 30. FIG. 12 depicts a three-dimensional refractive index profile of the tube fiber 30 used in the model of the fiber optic coupling system 44. The tube fiber 30 has a length l₁ of about 200 μm, an outer layer 42 with an index of refraction of about 1.450, and an inner layer 40 with an index of refraction of about 1.462. The inner layer 40 has a radial thickness of about 10 μm, and the inner diameter d₆ of the tube fiber 30 is about 110 μm. Each of the hollow-core optical fibers 10 was modeled has being made from a material having an index of refraction of about 1.440 (e.g., silica) and the same dimensions as described above with respect to FIG. 1.

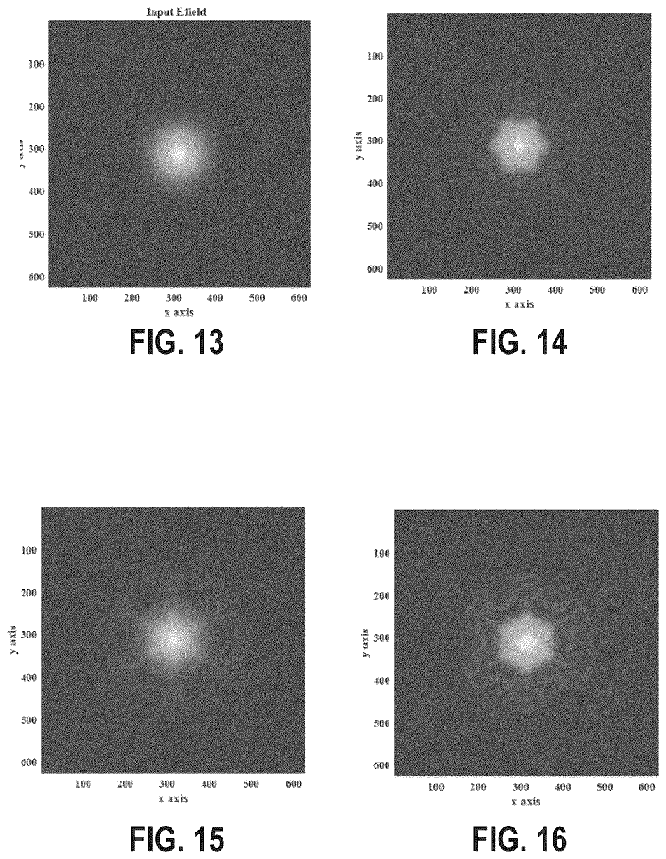

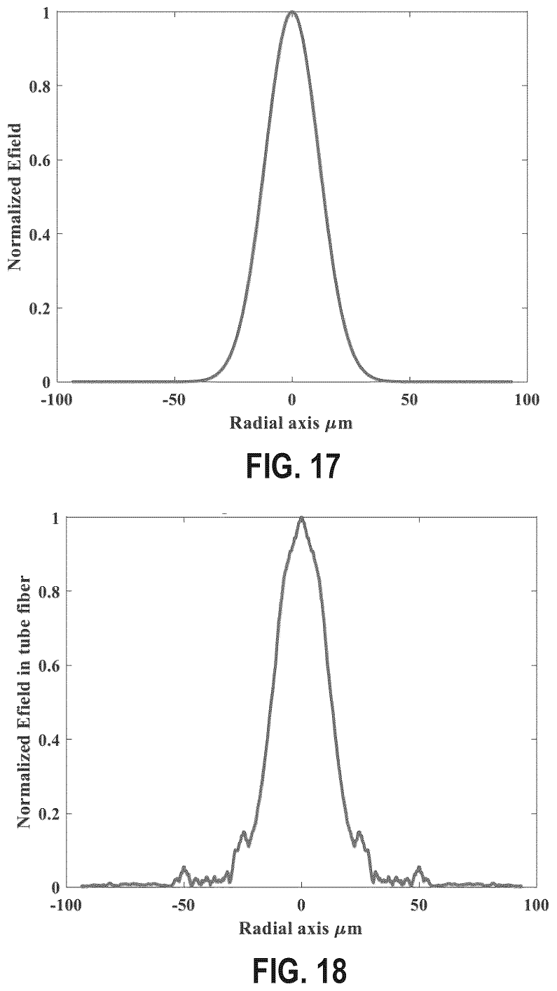

Optical simulations were used to generate E-field distributions across the fiber optic coupling system 44 depicted by FIGS. 11 and 12. The results of these simulations are shown by FIGS. 13-18, which depict graphs illustrating the E-field distribution of a beam of light 26 passing through the fiber optic coupling system 44 at different positions along the z-axis. FIG. 13 shows the E-field of a Gaussian beam provided as an input to the originating hollow-core optical fiber 10. FIG. 14 shows the E-field at the transition 28 between the originating hollow-core optical fiber 10 and the tube fiber 30. FIG. 15 shows the E-field at the transition 28 between the tube fiber 30 and the destination hollow-core optical fiber 10. FIG. 16 shows the E-field at the output end face 48 of the destination hollow-core optical fiber 10. FIGS. 17 and 18 depict graphs including a plot of the E-field profile of the input Gaussian beam (FIG. 17) and the E-field profile of the beam of light 26 at the transition 28 between the tube fiber 30 and destination hollow-core optical fiber 10 (FIG. 18).

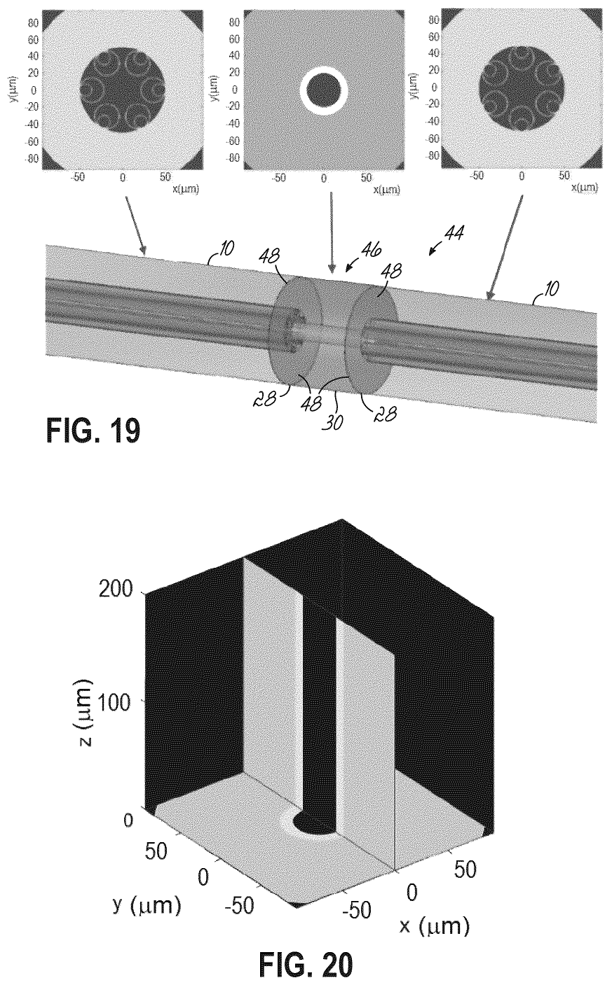

FIG. 19 depicts another exemplary embodiment of the fiber optic coupling system 44 that includes two hollow-core optical fibers 10 operatively coupled to each other by an optical coupler 46 comprising a length of tube fiber 30. FIG. 20 depicts a three-dimensional refractive index profile of the tube fiber 30 used in the model of the fiber optic coupling system 44. The tube fiber 30 has a length l₁ of about 200 μm, an outer layer 42 with an index of refraction of about 1.450, and an inner layer 40 with an index of refraction of about 1.462. The inner layer 40 has a radial thickness of about 10 μm and the inner diameter d₆ of the tube fiber 30 is about 40 μm. Thus, the tube fiber 30 is configured in a similar manner as the tube fiber 30 depicted by FIG. 12 except that the inner diameter d₆ is 40 μm instead of 110 μm.

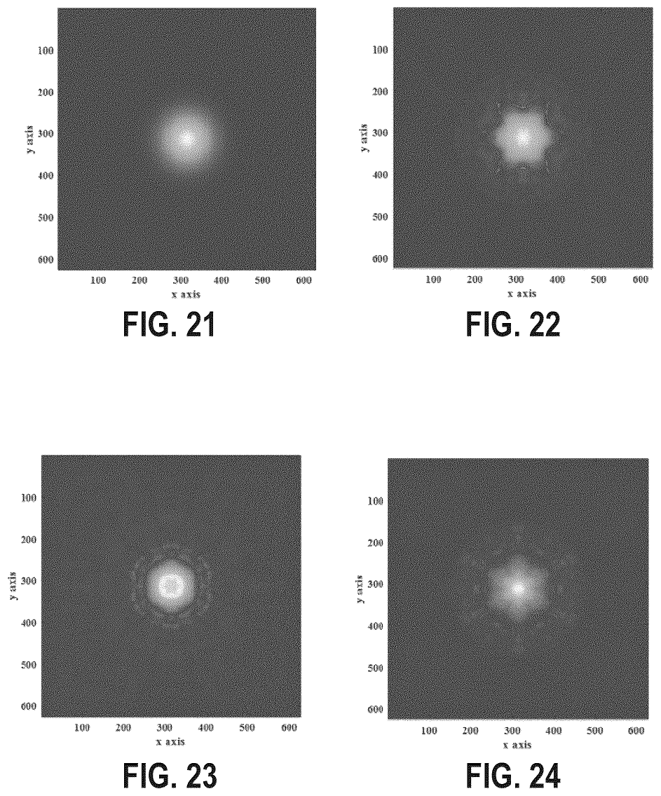

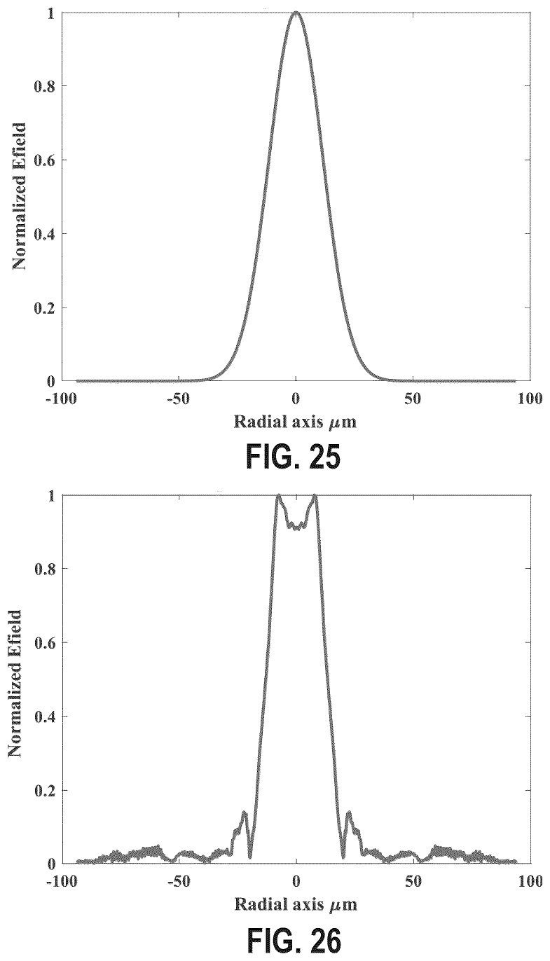

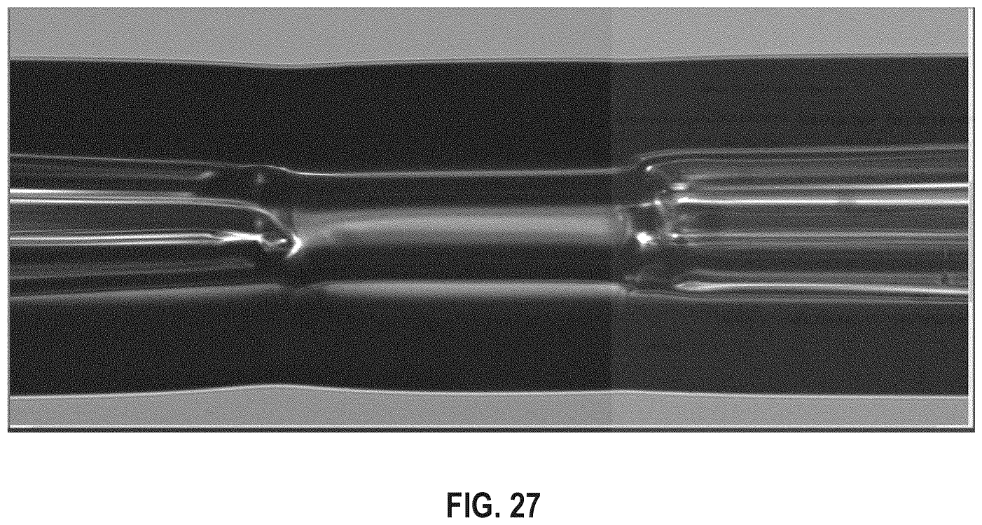

Optical simulations were used to generate E-field distributions across the fiber optic coupling system 44 depicted by FIGS. 19 and 20. The results of these simulations are shown by FIGS. 21-26, which depict graphs illustrating the E-field distribution of a beam of light 26 passing through the fiber optic coupling system 44 at different positions along the z-axis. FIG. 21 shows the E-field of a Gaussian beam provided as an input to the originating hollow-core optical fiber 10. FIG. 22 shows the E-field at the transition 28 between the originating hollow-core optical fiber 10 and the tube fiber 30. FIG. 23 shows the E-field at the transition 28 between the tube fiber 30 and the destination hollow-core optical fiber 10. FIG. 24 shows the E-field at the output end face 48 of the destination hollow-core optical fiber 10. FIGS. 25 and 26 depict graphs including a plot of the E-field profile of the input Gaussian beam (FIG. 25) and the E-field profile of the beam of light 26 at the transition 28 between the tube fiber 30 and destination hollow-core optical fiber (FIG. 26).

By comparing results between the exemplary fiber optic coupling systems 44, it can be seen that the width of the beam of light 26 at the transition 28 between the tube fiber 30 and destination hollow-core optical fiber 10 is generally narrower with the tube fiber 30 having the inner diameter d₆ of 40 μm than with the tube fiber 30 having the inner diameter d₆ of 110 μm. The beam of light 26 at the transition 28 between the tube fiber 30 and destination hollow-core optical fiber 10 more closely resembles that of the input Gaussian beam with the tube fiber 30 having the inner diameter d₆ of 110 μm than with the tube fiber 30 having the inner diameter d₆ of 40 μm. However, modeled coupling losses were 0.18 dB with the tube fiber 30 having the inner diameter d₆ of 110 μm and 0.13 dB with the tube fiber 30 having the inner diameter d₆ of 40 μm. The lower coupling loss produced by the optical coupler 46 having the tube fiber 30 with the inner diameter d₆ of 40 μm may be attributed to the 40 μm inner diameter da more closely matching the 32 μm nominal mode field diameter of the hollow-core optical fibers 10 than the 110 μm inner diameter d₆.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The present disclosure in its broader aspects is therefore not limited to the specific details, representative apparatus and methods and illustrative examples shown and described. Accordingly, departures may be made from such details without departing from the scope of the present disclosure.

What is claimed is:

1. A fiber optic coupling system, comprising:
a first hollow-core optical fiber including a first hollow-core optical fiber end face;
a tube fiber including a first tube fiber end face and a second tube fiber end face; and
a second hollow-core optical fiber including a second hollow-core optical fiber end face that is operatively coupled to the first hollow-core optical fiber end face by the tube fiber.

2. The system of claim 1, wherein:
the first hollow-core optical fiber end face is connected to the first tube fiber end face, and
the second hollow-core optical fiber end face is connected to the second tube fiber end face.

3. The system of claim 2, wherein:
the first hollow-core optical fiber end face is connected to the first tube fiber end face by a first fusion splice, and
the second hollow-core optical fiber end face is connected to the second tube fiber end face by a second fusion splice.

4. The system of claim 1, wherein the tube fiber has a length of between 180 μm and 220 μm.

5. The system of claim 1, wherein:
each hollow-core optical fiber includes a mode field diameter and a cladding having an inner cladding diameter larger than the mode field diameter; and
the tube fiber includes a lumen having a lumen diameter greater than or equal to the mode field diameter and less than or equal to the inner cladding diameter.

6. The system of claim 5, wherein:
each hollow-core optical fiber includes a hollow-core having a hollow-core diameter less than the inner cladding diameter and greater than the mode field diameter, and
the lumen diameter is greater than or equal to the mode field diameter and less than or equal to the hollow-core diameter.

7. The system of claim 6, wherein the lumen diameter is the same as the hollow-core diameter.

8. The system of claim 1, wherein the tube fiber includes:
a lumen having a lumen diameter,
an inner layer having a first index of refraction and a surface that defines the lumen diameter, and
an outer layer in contact with the inner layer and having a second index of refraction different from the first index of refraction.

9. The system of claim 8, wherein the first index of refraction is greater than the second index of refraction.

10. The system of claim 8, wherein the inner layer is configured to be an anti-resonant layer.

11. A method for coupling hollow-core optical fibers, comprising:
operatively coupling a first hollow-core optical fiber end face of a first hollow-core optical fiber to a first tube fiber end face of a tube fiber; and
operatively coupling a second hollow-core optical fiber end face of a second hollow-core optical fiber to a second tube fiber end face of the tube fiber.

12. The method of claim 11, wherein:
operatively coupling the first hollow-core optical fiber end face to the first tube fiber end face includes connecting the first hollow-core optical fiber end face to the first tube fiber end face, and
operatively coupling the second hollow-core optical fiber end face to the second tube fiber end face includes connecting the second hollow-core optical fiber end face to the second tube fiber end face.

13. The method of claim 12, wherein:
connecting the first hollow-core optical fiber end face to the first tube fiber end face includes fusion splicing the first hollow-core optical fiber end face to the first tube fiber end face, and
connecting the second hollow-core optical fiber end face to the second tube fiber end face includes fusion splicing the second hollow-core optical fiber end face to the second tube fiber end face.

14. The method of claim 11, wherein the tube fiber has a length of between 180 μm and 220 μm.

15. The method of claim 11, wherein:
each hollow-core optical fiber includes a mode field diameter and a cladding having an inner cladding diameter larger than the mode field diameter, and
the tube fiber includes a lumen having a lumen diameter greater than or equal to the mode field diameter and less than or equal to the inner cladding diameter.

16. The method of claim 15, wherein:
each hollow-core optical fiber includes a hollow-core having a hollow-core diameter less than the inner cladding diameter and greater than the mode field diameter, and
the lumen diameter is greater than or equal to the mode field diameter and less than or equal to the hollow-core diameter.

17. The method of claim 16, wherein the lumen diameter is the same as the hollow-core diameter.

18. The method of claim 11, wherein the tube fiber includes:
a lumen having a lumen diameter,
an inner layer having a first index of refraction and a surface that defines the lumen diameter, and
an outer layer in contact with the inner layer and having a second index of refraction different from the first index of refraction.

19. The method of claim 18, wherein the first index of refraction is greater than the second index of refraction.

20. The method of claim 18, wherein the inner layer is configured to be an anti-resonant layer.
